(19) United States
(12) Patent Application Publication
(10) Pub. No.: US 2009/0024249 A1
(43) Pub. Date: Jan. 22, 2009

(54) METHOD FOR DESIGNING GENETIC CODE FOR SOFTWARE ROBOT

(76) Inventors: Kang-Hee Lee, Seoul (KR); Kwang-Choon Kim, Suwon-si (KR); Jong-Hwan Kim, Daejeon (KR); Seung-Hwan Choi, Daejeon (KR)

Correspondence Address: CHA & REITER, LLC, 210 ROUTE 4 EAST STE 103, PARAMUS, NJ, 07652, US

(21) Appl. No.: 12/173,905

(22) Filed: Jul. 16, 2008

(30) Foreign Application Priority Data
Jul. 16, 2007 (KR) 71229/2007

(51) Int. Cl. G06F 19/00; B25J 13/00

(52) U.S. Cl. 700/245; 901/50

(57) ABSTRACT

A method for designing a genetic code for a software robot in a software robot apparatus is provided in which a request for writing a genetic code for a software robot is received from a user, a plurality of intuition traits associated with one or more pieces of genetic information among genetic information included in the genetic code are provided, a value of an intuition trait selected from among the plurality of intuition traits is changed according to a user input, a representation value of each piece of genetic information related to the selected intuition trait is changed by applying the changed value of the intuition trait to a predetermined conversion formula, and the software robot is implemented according to representation values of the genetic information included in the genetic code, an external stimulus, and an internal state change of the software robot.

### CLAIM OF PRIORITY

This application claims the benefit of an earlier Korean Patent Application filed in the Korean Intellectual Property Office on Jul. 16, 2007 and assigned Serial No. 2007-71229, the entire contents of which is hereby incorporated by reference.

### BACKGROUND OF THE INVENTION

1. Field of the Invention

The present invention generally relates to a genetic robot. More particularly, the present invention relates to a method for designing a genetic code for a software robot as a genetic robot.

2. Description of the Related Art

A genetic robot is defined as an artificial creature, a software robot (Sobot), or a general robot that has its own genetic codes. A genetic code of a robot is a single robot genome composed of multiple artificial chromosomes. A software robot is a software artificial creature that can move through a network and act as an independent software agent interacting with a user and as the brain of a robot that interfaces between a hardware robot and a sensor network. The term “Robot” generically refers to a robot having typical components of senses, intelligence, and behavior in a physical environment. Accordingly, in the case where the software robot serves as the brain of a robot, obviously the present invention is equally valid in a common robot. The brain of a robot can be replaced with a software robot either through a network or another storage medium in a ubiquitous environment transcending time and space or by embedding it in the robot during manufacture of the robot.

Genetic codes or multiple artificial chromosomes implanted into a software robot dictate individuality or personality peculiar to the robot, which determine items such as, but not limited to, change of internal states including motivation, homeostasis, emotion, and the resulting behavior, while interacting with an external environment. The definitions of artificial creature, motivation, homeostasis, emotion, and behavior are given in Table 1 below.

TABLE 1

| | |
|---|---|
| Artificial creature | Acts on its own motivation, has emotions, and can select its |
| | behavior, interacting with a human being in real time. |
| Personality | Not a simple summary of behavior but a determiner of part or the |
| | whole of the behavior. Equivalent to human personality, when |
| | considering the robot human. A concept including motivation, |
| | homeostasis, and emotions. Namely, a personality engine |
| | corresponds to an engine having all of motivation, homeostasis, |
| | and emotions. A determiner that generates various kinds of |
| | internal states and triggers behaviors. |
| Motivation | A process that motivates and keeps activities of a living thing, and |
| | controls the pattern of the activities. Causes of selecting and |
| | executing behaviors. For example, desire to satisfy curiosity, to |
| | achieve intimacy, to prevent boredom, to avoid unpleasantness, to |
| | satisfy greed, to achieve control, etc. |
| Homeostasis | A function which keeps an organism physiologically stable as an |
| | individual even if it is incessantly affected by changes of external |
| | and internal environments. Causes of selecting and executing |
| | behaviors. For instance, including but not limited to states of |
| | hunger, drowsiness, fatigue, fear. |
| Emotion | A subjective feeling accompanying a certain activity. For example, |
| | including but not limited to happiness, sadness, anger, fear, and the like. |
| Behavior | A generic term for an individual's activities, including but not |
| | limited to moving to a specific spot and stopping. For instance, for |
| | animals, including but not limited to sleeping, feeding and |
| | running. The number of kinds of behaviors that an individual can |
| | select is limited, and at a certain instant, each individual can |
| | execute only one behavior. |

An artificial chromosome includes fundamental genetic information, internal state genetic information, and behavior selection genetic information. The fundamental genetic information refers to fundamental parameters that have a great effect on a change in internal states and external behaviors. The internal state genetic information is parameters that affect internal states of a robot in relation to an external input to the robot. Furthermore, the behavior selection genetic information refers to parameters that determine external behaviors based on the above internal states, depending on currently determined internal states.

The internal states include motivation, homeostasis and emotion. As noted from Table 2 below, the internal states of the robot can be determined by their sub-internal states and parameters of the internal states for respective external stimuli, i.e., genetic information related to the internal states.

TABLE 2

| | Internal states | | | | | | | | |
|---|---|---|---|---|---|---|---|---|---|
| External | Motivation | | | Homeostasis | | | Emotions | | |
| stimuli | Intimacy | . . . | Hostility | Hunger | . . . | Drowsiness | Happiness | . . . | Sadness |
| patting | 80 | . . . | −40 | 0 | . . . | 0 | 40 | . . . | −20 |
| beating | −30 | . . . | 50 | 0 | . . . | 0 | −30 | . . . | 30 |
| surprising | 0 | . . . | 5 | 0 | . . . | 0 | 10 | . . . | 0 |
| . . . | . . . | . . . | . . . | . . . | . . . | . . . | . . . | . . . | . . . |
| soothing | 40 | . . . | −40 | 0 | . . . | 0 | 50 | . . . | −50 |

The same can be said for the behavior selection genetic information, except that the behavior selection genetic information includes various expressible behaviors, instead of the external stimuli. That is, the behavior selection genetic information includes parameters related to specific behaviors for respective internal states, i.e. parameters of internal states, such as motivation, homeostasis, and emotions, which have values capable of triggering respective behaviors.

Fundamental parameters that have a great effect on a change of each internal state and external behavior may include a volatility, an initial value, a mean value, a convergence value, an attenuation value over time and a specific value determined by a specific time. These fundamental parameters may constitute fundamental genetic information. Hence, the fundamental genetic information can include: a volatility, an initial value, a mean value, a convergence value, an attenuation value and a specific value for each of the internal states, motivation, homeostasis, and emotion. As described above, a robot genome includes the fundamental genetic information, the internal state genetic information, and the behavior selection genetic information. The fundamental genetic information includes internal states and parameters of elements that are fundamental to a change of the internal states and execution of external behaviors. The internal state genetic information includes various external stimuli and parameters of internal states to the external stimuli. The behavior selection genetic information includes various behaviors and parameters of internal states in response to the behaviors. Namely, as noted from Table 3 below, the robot genome can represent, in a two-dimensional matrix, respective internal states and genetic information about fundamental elements, external stimuli, and behaviors related to the internal states.

TABLE 3

| Motivation | | | Homeostasis | | | Emotion | | |
|---|---|---|---|---|---|---|---|---|
| Intimacy | . . . | Hostility | Hunger | . . . | Drowsiness | Happiness | . . . | Sadness |

| | | | | |
|---|---|---|---|---|
| Fundamental | Volatility | Fundamental genes | Fundamental genes | Fundamental genes |
| elements | Initial | (motivation) | (homeostasis) | (emotion) |
| | value | | | |
| | . . . | | | |
| | Attenuation | | | |
| | Value | | | |
| External | Patting | Internal state genes | Internal state genes | Internal state genes |
| stimuli | Beating | (motivation) | (homeostasis) | (emotion) |
| | . . . | | | |
| | Soothing | | | |
| Expressed | Laughing | Behavior selection | Behavior selection | Behavior selection |
| behaviors | Looking | genes (motivation) | genes (homeostasis) | genes (emotion) |
| | around | | | |
| | . . . | | | |
| | Rolling | | | |

Therefore, a current robot platform chooses a specific behavior based on current internal states, such as motivation, homeostasis, and emotion, and executes the behavior. For example, if a robot feels hungry in its internal state, it chooses a behavior of teasing and accordingly teases for something. Thus, the robot can be imbued with life. The software robot having these characteristics provides a user with services without restrictions on time and space in a ubiquitous environment. Therefore, to enable the software robot to freely move over a network, it is given a mobile Internet Protocol (IP) address.

As described above, a conventional software robot perceives information, defines the internal states, motivation for motivating a behavior, homeostasis for maintenance of life, and emotion expressed by a facial expression based on the perceived information, and then selects a final behavior based on the internal states. Accordingly, a conventional software robot apparatus includes a perception module for perceiving an external environment, an internal state module for defining internal states, such as emotion, a behavior selection module for selecting a proper behavior based on the external information and the internal states, a learning module for adapting the software robot to external states, and an actuator module for executing the selected proper behavior. The software robot (Sobot) apparatus can store a plurality of software robot genetic codes and accordingly realize a plurality of software robots in a virtual space. Although the Sobot apparatus senses information, changes internal states, and executes a behavior in the same algorithm for each software robot, different results are achieved due to different characteristics of the software robots, i.e. their genetic codes, despite their responding to a same external situation. The genetic codes of a software robot determine its traits and personality. Conventionally, there are neither algorithms nor frameworks for imbuing software robots with personality. In general, software robot providers or developers determine a main character, i.e. genetic codes for a software robot in an early stage of manufacture. While a user can teach a software robot some traits in direct interaction with it, it is almost impossible to change the entire personality of the software robot. This is because the user is not familiar with the internal structure of the software robot and if ever, parameters of each genetic information are so entangled linearly or non-linearly that the software robot looses its own personality as an artificial creature when a comprehensive modification is made to it.

### SUMMARY OF THE INVENTION

Exemplary embodiments of the present invention address at least the problems and/or disadvantages and provide at least the advantages described below. Accordingly, exemplary embodiments of the present invention provide a method for changing a genetic code of a software robot in an intuitive and user-friendly manner.

In accordance with an exemplary embodiment of the present invention, there is provided a method for designing a genetic code for a software robot in a software robot apparatus, in which a request for writing a genetic code for a software robot is received from a user, a plurality of intuition traits associated with one or more pieces of genetic information among genetic information included in the genetic code are provided, a value of an intuition trait selected from among the plurality of intuition traits is changed according to a user input, a representation value of each piece of genetic information related to the selected intuition trait is changed by applying the changed value of the intuition trait to a predetermined conversion formula, and the software robot is implemented according to representation values of the genetic information included in the genetic code, an external stimulus, and an internal state change of the software robot.

In accordance with another exemplary embodiment of the present invention, there is provided a method for designing a genetic code for a software robot in a software robot apparatus, in which genetic codes of one or more software robots are set as genetic codes of a pair of parent software robots, and new genetic information is created by combining paired homologous chromosomes of genetic information counterparts included in genetic information provided by the genetic codes of the parent software robots, according to a predetermined gene crossover rule.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 is a block diagram of a software robot apparatus, according to an exemplary embodiment of the present invention;

FIG. 2 illustrates an intuition trait writing window, according to an exemplary embodiment of the present invention;

FIG. 3 illustrates a detailed writing window, according to an exemplary embodiment of the present invention;

FIG. 4 is a flowchart illustrating an operation for changing intuition traits, according to an exemplary embodiment of the present invention;

FIG. 5 is a flowchart illustrating a crossover operation, according to an exemplary embodiment of the present invention;

FIG. 6 illustrates the compositions of artificial chromosomes of parents and children, according to an exemplary embodiment of the present invention;

FIGS. 7A to 7D illustrate a crossover between different parents, according to an exemplary embodiment of the present invention;

FIGS. 8A and 8B illustrate a self-crossover according to an exemplary embodiment of the present invention;

FIG. 9 illustrates a screen having a cyberspace and a user menu, according to an exemplary embodiment of the present invention; and

FIG. 10 is a flowchart illustrating a behavior selection operation, according to an exemplary embodiment of the present invention.

Throughout the drawings, the same drawing reference numerals will be understood to refer to the same elements, features and structures.

### DETAILED DESCRIPTION OF THE INVENTION

The matters defined in the description, such as, a detailed construction and elements, are provided to assist in a comprehensive understanding of exemplary embodiments of the present invention. Accordingly, those of ordinary skill in the art will recognize that various changes and modifications of the embodiments described herein can be made without departing from the scope and spirit of the invention. For the purposes of clarity and simplicity, descriptions of well-known functions and constructions are omitted for clarity and conciseness.

Typically, a software robot is a software artificial creature having its unique genetic codes, which can act as an independent software agent interacting with a user and as the intelligence of a robot interfacing between a hardware robot and a sensor network, while moving over a network. “Robot” is a generic term for an artificial creature having components, perception, intelligence, and behavior in a physical environment. Accordingly, in the case where the software robot serves as the intelligence of a robot, it is clear that the present invention is equally valid to general robots. A software robot can be implemented as the intelligence of a robot either through a network or another storage medium in a ubiquitous environment transcending time and space. Alternatively, the software robot can be embedded into the robot in the process of manufacture.

Genetic codes are defined specific to each software robot, as a single robot genome composed of multiple artificial chromosomes. In accordance with the present invention, the genetic codes are classified into personality genes related to the internal state of the software robot and outward genes related to its outward appearance.

The outward genes provide a plurality of pieces of outward genetic information that determine the outward appearance of the software robot, such as face genetic information, eye genetic information, etc.

The personality genes dictate a robot personality that determines changes of internal states including motivation, homeostasis and emotion and a corresponding resultant behavior manifestation, while interacting with an external environment. The personality genes provide fundamental genetic information, internal state genetic information, and behavior determination genetic information.

The fundamental genetic information refers to fundamental parameters that significantly affect internal state changes and behavior manifestation.

The internal state genetic information refers to parameters that affect the internal state of the robot in relation to an external input.

The behavior determination genetic information refers to parameters that determine behaviors related to internal states according to currently defined internal states.

As illustrated in Table 3, the personality genes can be represented in a two-dimensional matrix of internal states and genetic information about fundamental elements, external stimuli, and behaviors in relation to the internal states.

In accordance with the present invention, the parameters of genetic information that the personality genes and the outward genes provide are referred to as representation values, which affect the outward appearance, internal state changes, and behavior manifestation of the software robot. That is, while a software robot apparatus carries out a series of outward appearance creation, perception, changing internal states, and behavior manifestation for each software robot by the same algorithm, it derives different results according to the representation values of genetic information included in genetic codes specific to each software robot.

According to an exemplary embodiment of the present invention, each piece of genetic information can be composed of a pair of homologous chromosomes having chromosomal values. The homologous chromosomes can be identical or different. The representation value of genetic information is related to the chromosomal values of the genetic information and an algorithm for representing such relations is defined as an inheritance law. In other words, the chromosomal values of the homologous chromosomes of genetic information determine the representation value of the genetic information. If the representation value changes, the chromosomal values can also change.

Notably, an inheritance law that determines the relationship between chromosomal values and a representation value can be set in various ways. For instance, the inheritance law can be set to be the law of intermediate inheritance such that the mean of the chromosomal values is equal to the representation value. Or, the inheritance law can be established through application of biological inheritance laws such as Mendelian genetics, the law of independence assortment, the law of segregation, and the law of dominance. For example, a dominant homologous chromosome and a recessive homologous chromosome are set for genetic information according to the type of the genetic information and the inheritance law is set such that the representation value is equal to the chromosomal value of the dominant homologous chromosome. While it has been described above that the representation value depends on the homologous chromosomal values, by way of example, a change in the representation value may lead to a change in its associated chromosomal value according to the inheritance law. In the case where the representation value is the mean of the chromosomal values, half the representation value is the chromosomal value of each homologous chromosome in the pair. When the law of dominance is applied, the changed representation value is the chromosomal value of the dominant homologous chromosome.

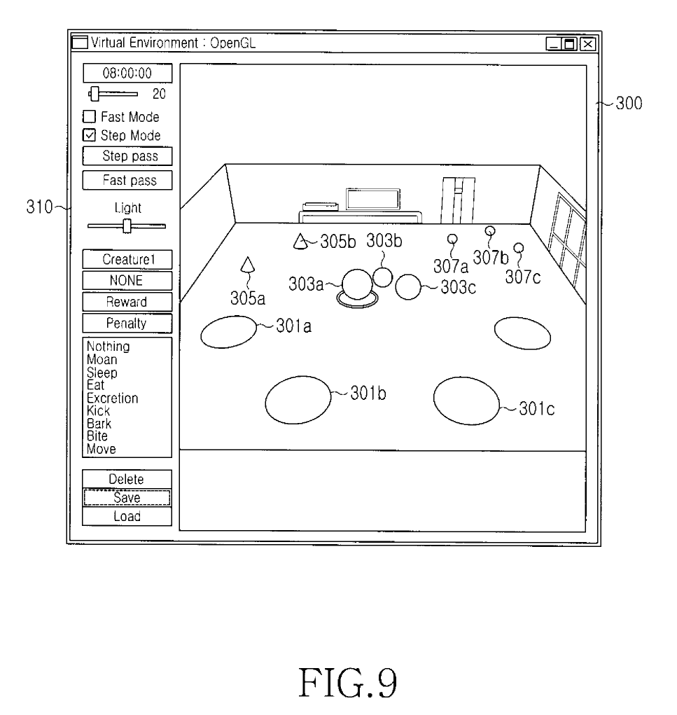

In nature, the software robot lives in cyberspace. According to the present invention, one or more software robots are alive in the cyberspace and well as many other items including, for example, accessories, food, toys, and chairs, as illustrated in FIG. 9.

FIG. 9 illustrates a screen having a cyberspace 300 and a user menu 310 according to an exemplary embodiment of the present invention.

Referring to FIG. 9, a plurality of spots 301a, 301b and 301c, a plurality of toys 305a and 305b, a plurality of food items 307a, 307b and 307c, and a plurality of software robots 303a, 303b and 303c are placed into the cyberspace 300. The software robots 303a-c and all other components existing in the cyberspace are referred to as objects according to the present invention. According to the present invention, a software robot apparatus can construct the cyberspace for a user and control multiple objects existing in the cyberspace according to an internal logic or in response to the user's input. As environmental factors change, or objects move or interact with each other in the cyberspace, environmental information, which includes environmental factor information and object location information, and object interaction information can be generated. The environmental factors represent environmental characteristics of the cyberspace, including, but not limited to, temperature, humidity, time, light intensity, sound and spatial characteristics. The object location information refers to information indicating the locations of stationary objects or the current locations of moving objects in the cyberspace. The object interaction information is about direct interactions between the objects. It can be generated usually when one software robot interacts with another object. For instance, the object interaction information is created when a software robot eats food or when software robot a hits software robot b.

According to the present invention, the software robot apparatus can apply the environmental information to all software robots within the cyberspace as it is, or only to associated software robots as an event. The software robot apparatus provides the environmental factors and the object location information to all software robots in the cyberspace without processing them, generally by specific functions. A sensor unit in the software robot apparatus senses the environmental factors and the object location information and then applies them to each software robot. The object interaction information can be delivered to each software robot as an event, which can be expressed by a specific function.

The event is used to apply the effects of an incident that happens in the cyberspace to software robots. The event includes identification information about objects involved in the incident, i.e. subjective object identification information about an object that causes the incident (who) and target object identification information about an object affected by the incident (whom), information about the type of a behavior associated with the incident (what), and information about the effects of the behavior (parameter). The effect information includes an effect that is exerted on the subjective object. The event can be classified as an external event or an internal event depending on whether it is an interaction between different objects or it occurs within an object. In the external event, subjective object identification information is different from target object identification information. For example, in an event where “a software eats food”, the subjective object is “software robot”, the target object is “food”, the behavior type is “eat”, and the resulting effect can be “feeling full and happy”. If objects involved in an incident are all software robots, an external event can be produced for each software robot.

The internal event occurs within a software robot as a result of some behavior, characterized by subjective object identification information being identical to target object identification information. For example, in an internal event “a software robot walks”, the subjective and target objects are both “software robot”, the behavior type is “walk”, and the resulting effect can be “fatigue”. The software robot apparatus can sense the occurrence of an event through a sensor unit or a physical state unit and applies the event to an associated software robot.

In accordance with an exemplary embodiment of the present invention, the environmental information can be represented by use of parameters and functions as defined in Tables 4, 5 and 6 below, for application to associated software robots. Table 4 illustrates a member function of an object class associated with objects existing in the cyberspace, Table 5 lists member parameters of an environment class associated with environmental factors that can be created for the cyberspace, and Table 6 illustrates important functions and functionalities of an environmental factor class.

TABLE 4

| Parameters | Description | Notes |
|---|---|---|
| m_type | Identifies object type | Food, toy, software robot |
| m_id | Unique number that identifies | |
| | object | |
| m_name | Name of object | |
| m_size | Size of object | |
| m_pos | Location of object | |
| m_dir | Direction of object | |
| m_calorie | Energy contained in food | Food type |
| m_taste | Taste of food | Food type |
| m_sound | Sound texture measure of object | Toy type |

TABLE 5

| Parameters | Description |
|---|---|
| m_EventSet | A set of events that happen among objects |
| | in cyberspace |
| m_EnvironmentOutputData | Environmental factor information |
| | applied to software robot |
| m_objectN | Number of objects existing in cyberspace |
| m_object[ ] | Layout of objects |
| m_creatureN | Number of software robots existing in |
| | cyberspace |
| m_creature[ ] | Layout of software robots |

TABLE 6

| Important functions | Description |
|---|---|
| InitEnvironment | Initializes object in cyberspace |
| ShowEnvironment | Implements appropriate user |
| | input/output |
| UpdateEnvironmentInformation | When software robot information |
| | displayed on a screen is changed by |
| | user, updates the software robot |
| | information according to the change |
| UpdateSensor | Provides environmental factor data to |
| | each software robot |
| UpdateEvent | Provides external event to each |
| | software robot |
| EventReset | Initializes external event |
| CreatureActivation | Implements software robot |
| AddEventFromCreature | Creates new event |

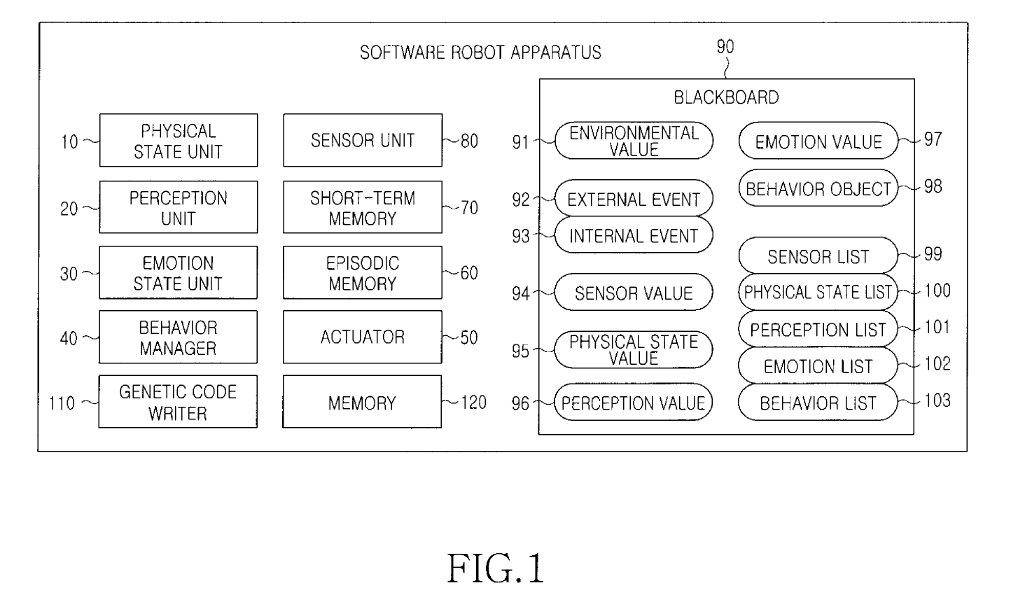

The software robot apparatus having the above-described features can be configured as illustrated in FIG. 1, according to the present invention. As stated above, a plurality of software robots may exist in a cyberspace provided by a single software robot apparatus and each software robot can be managed and controlled in the same manner.

FIG. 1 is a block diagram of a software robot apparatus according to an exemplary embodiment of the present invention.

Referring to FIG. 1, the software robot apparatus includes a physical state unit 10, a perception unit 20, an emotion state unit 30, a behavior manager 40, a sensor unit 80, a short-term memory 70, an episodic memory 60, an actuator 50, a blackboard 90, a genetic code writer 110, and a memory 120.

The software robot apparatus has a variety of modules including the above-described physical state unit 10, perception unit 20, emotion state unit 30, behavior manager 40, sensor unit 80, and actuator 50. The modules exchange preset data, bearing complicated relations to one another. Unless the complicated relations are unified, the type of data to be sent and received and a transmission and reception scheme for the data should all be defined for each relation during the stage of implementation of the software robot apparatus.

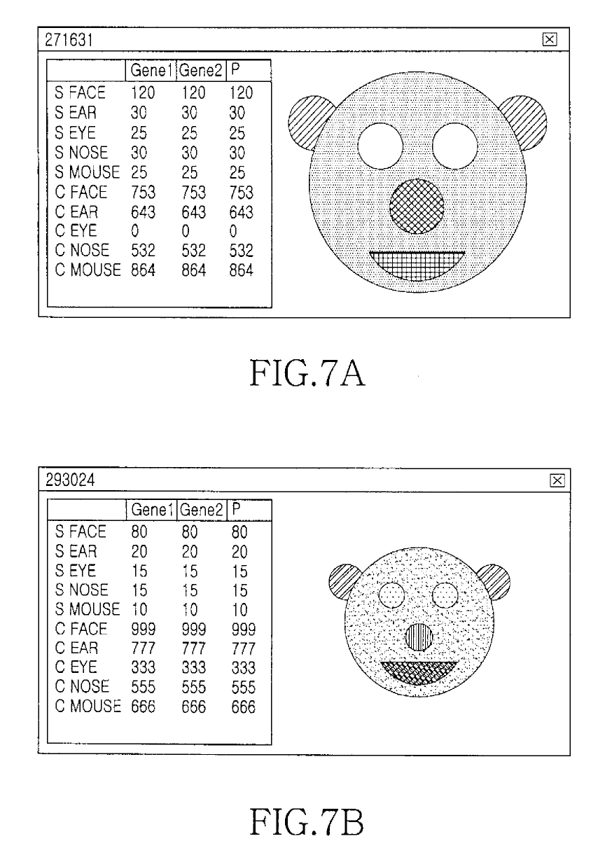

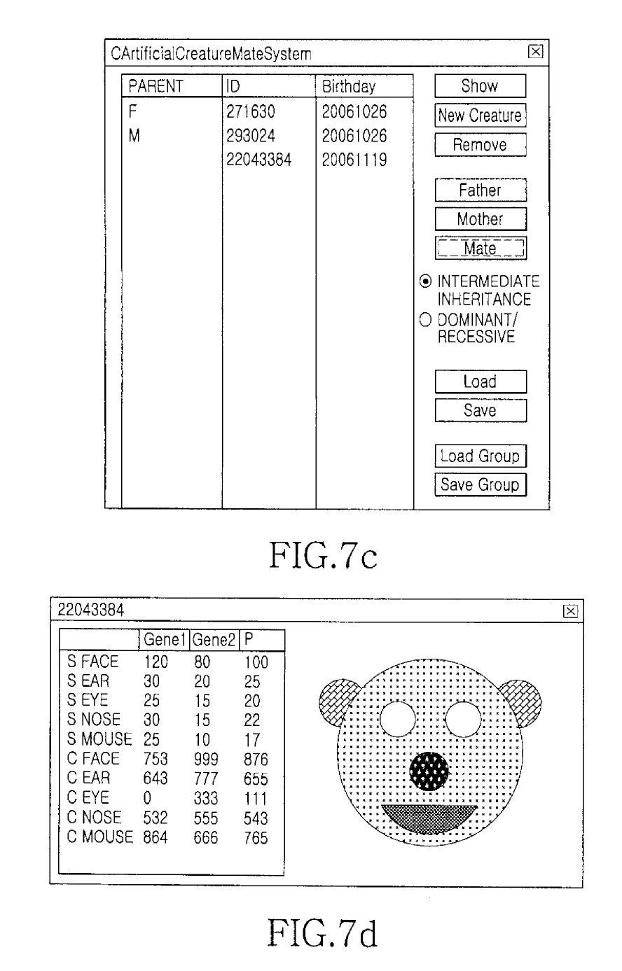

The blackboard 90 is used to relieve implementation inconvenience. It has such a structure as can be shared among various modules and used as means for integrating a variety of information resources. This structure is based on the concept that a number of persons write necessary information on a blackboard to share it with one another in order to solve a complex problem. The structure has a common data area corresponding to a blackboard at the center, in which information from a plurality of modules is integrated. The blackboard 90 is configured as a Cblackboard class. The Cblackboard class has various data structures as illustrated in FIGS. 7A to 7D. Each piece of data information is provided to each module that constitutes a virtual creature or updated from each module by a predetermined Put function and Get function.

TABLE 7

| Structure | Description |
|---|---|
| Environmental | Virtual environmental information provided to |
| value 91 | software robot |
| External event 92 | Information about incident occurring in cyberspace |
| Internal event 93 | Information about incident occurring inside software |
| | robot |
| Sensor value 94 | cyberspace information sensed by software robot |
| Physical state | Physical state value of software robot |
| value 95 | |
| Perception value 96 | Perception information of software robot |
| Emotion value 97 | Dominant emotion value of software robot |
| Behavior object 98 | Selected behavior and its associated object |
| Sensor list 99 | List of senses associated with software robot |
| Physical state | List of all physical states associated with software |
| list 100 | robot |
| Perception list 101 | List of all perceptions associated with software robot |
| Emotion list 102 | List of all emotions associated with software robot |
| Behavior list 103 | List of all behaviors associated with software robot |

The software robot apparatus is equipped with a short-term memory, a long-term memory, and a working memory, on the whole. As implied from its appellation, the short-term memory 70 is a short-term one, the episodic memory 60 is a long-term memory, and the memory 120 is a working memory. The short-term memory 70 stores latest information generated for a short time, deletes part of the latest information, and transfers another part to the long-term memory. In accordance with an exemplary embodiment of the present invention, the short-term memory 70 stores information about the external environment of the software robot.

The sensor unit 80 updates internal sensor data for the input of environmental information, i.e. an environmental value 91 and an external event 92 on the blackboard 90, and outputs sensor data affecting the software robot as a sensor value 94 to the blackboard 90. All information about the cyberspace is applied to the software robot in the form of environmental information and external events. Yet, there may exist information that eludes sensing regarding the cyberspace depending on the current location and capability of the software robot. Therefore, the sensor unit 80 functions as a filter for filtering only information sensible to the software robot from sensed information, for application to the software robot. For example, information about an object beyond the sight of the software robot is not included in the sensor value 94 and an external event not related to the software robot is not processed either.

The physical state unit 10 updates physical state data by changing physical states of the software robot, referring to the external event 92, an internal event 93, and the environmental information on the blackboard 90, and outputs a final physical state value as a physical state value 95 to the blackboard 90. Physical states related to each external event 92, each internal event 93, and each piece of environmental information and variations of the physical states with respect to the external event 92, the internal event 93, and the environmental information are preset according to the genetic information included in the genetic codes of each software robot. The physical states can include intake, energy, excretion desire, activity, health, and physical growth, as listed in Table 8.

TABLE 8

| State | Description | Effects |
|---|---|---|
| Intake (Stomach) | Food intake before digestion | Hunger |
| Energy | Possessed energy level | Digestion activity |
| Excretion desire | Amount of wastes to be | Excretion |
| | excreted | |
| Activity | Vigor of Activity | Fatigue |
| Health | Health state | Activity |
| Physical growth | Physical growth level | Outward appearance |
| | | of virtual creature |

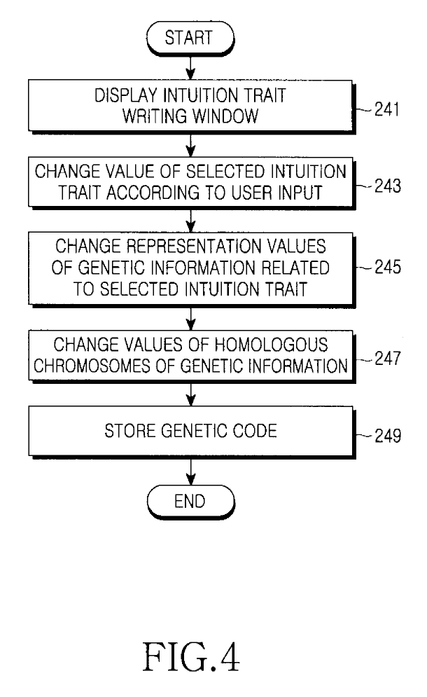

The perception unit 20 is a module for managing the results of perceiving the environmental information of the cyberspace and perceiving the physical states by the software robot. The perception unit 20 perceives an external environment sensed by the sensor value 94 and output thereby on the blackboard 90 and an internal state of the software robot represented by the physical state value 95, updates perception data, and outputs the update as a perception value 96 to the blackboard 90. Perception states associated with each sensor value and each physical state are predetermined. The relationship between the perception unit 20 and the blackboard 90 is depicted in FIG. 4.

For example, if the perception unit 20 receives information indicating that the software robot has been hit with power level 100 from the sensor unit 100, it can get a perception of “feeling painful”. If the preserved energy level drops below level 10, the perception unit 20 gets a perception of “feeling hungry”. In accordance with the present invention, the perception value 96 is expressed in two values, P_{TRUE} and P_{FALSE} indicating affirmative and negative perceptions regarding a given perception state. In general,

P_{TRUE}+P_{FALSE}=1 (1)

For example, if the perception state is “hunger”, feeling hungry can be an affirmative perception represented by P_{TRUE} and feeling full can be a negative perception represented by P_{FALSE}. In accordance with an exemplary embodiment of the present invention, the types of perception states can be defined as illustrated in Table 9.

TABLE 9

| State | Description |
|---|---|
| Light | Brightness of virtual environment |
| Sound | Sound level created in virtual environment |
| Taste | Taste of eaten food |
| Hunger | Hunger level |
| Fatigue | Fatigue level |
| Hit | How hard virtual creature is hit in incident occurring in virtual |
| | environment |
| Pat | How much virtual creature is pat in incident occurring in virtual |
| | environment |

The perception unit 20 is equipped with the function of changing sensitivity when it is exposed continuously to the same stimulus. Sensitivity, which is a measure of feeling a stimulus, is set for each stimulus and affects a variation in each perception state. A different sensitivity can be set for each stimulus. Also, the sensitivity can be set so as to change adaptively according to the number of successive occurrences of the same sensitivity. When a stimulus continues, the sensitivity to the stimulus decreases gradually to 0. If the stimulus is not felt for a predetermined time period, the sensitivity returns to its original level.

The emotion state unit 30 is a module for managing emotion states of the software robot. It changes emotion states of the software robot, referring to the perception value 96 on the blackboard 90, updates emotion state data accordingly, and outputs the update as an emotion value 97 to the blackboard 90. Emotion states associated with each perception state are predetermined. Each emotion state can be changed by use of the perception value 96 as follows.

Eⱼ(t+1)=wᵢ_{_{P}}wⱼ_{_{E}}(M_{TRUE}Pᵢ_{_{TRUE}}+M_{FALSE}Pᵢ_{_{FALSE}})+λ(Eⱼ(0)−Eⱼ(t)) (2)

where Eⱼ(t) denotes a current emotion value, Eⱼ(t+1) denotes a changed emotion value, and Eⱼ(0) denotes a default emotion value to which the emotion converges when there is no stimulus. A constant that determines the speed of convergence is λ. Pᵢ_{_{TRUE}} and Pᵢ_{_{FALSE}} are fuzzy values for TRUE and FALSE of the perception value 96. M_{TRUE} and M_{FALSE} are matrices for converting the perception value 96 to an emotion variation. wᵢ_{_{P}} and wⱼ_{_{E}} are weights applied to the perception value 96 and the emotion state, respectively. In accordance with an exemplary embodiment of the present invention, emotion states may include happiness, sadness, anger, and fear and the emotion state unit 30 determines an emotion state having the largest value among the emotion states to be a dominant emotion.

The memory 120 stores unstable state ranges and genetic codes corresponding to each software robot. It also stores physical states, perception states, emotion states, and behavior types defined for each software robot, information about relations between each behavior type and its associated perception states, physical states, and emotion states, and variations in the emotion states and the physical states in correspondence with the behavior type. This information can be included as genetic information in genetic codes.

The episodic memory 60 is a module that takes charge of learning relations between behavior and perception and between behavior and emotion for the software robot, referring to the perception value 96 and the emotion value 97. The episodic memory 60 determines an episode and a behavior object 98, referring to the perception value 96 and the emotion value 97. The episodic memory 60 stores as a plurality of learnings, a plurality of episodes, each episode being information representing a combination of a perception state and an emotion state among internal states defined for the software robot, an object existing in the cyberspace, and a behavior type. Thus, each episode can express a relationship among a behavior, a perception state, an emotion state, and an object in a combination corresponding to the episode. The episodes include behavior, object, category, state, value, and frequency as parameters and their meanings are given in Table 10.

TABLE 10

| | Description |
|---|---|
| Behavior | Identifies behavior that has been selected and executed |
| Object | Identifies object associated with behavior |
| Category | Indicates whether the episode is a memory related to |
| | perception state or emotion state. It has value |
| | “perception” or value “emotion” |
| State | Identifies perception state or emotion state according to |
| | Category. Initial value is 0. |
| Variation | Variation of perception or emotion state |
| Frequency | The number of learnings of the same combination of |
| | behavior, object and state. Initial value is 0. |

The total number of episodes stored in the episodic memory 60 and the resulting maximum size of the episodic memory 60 are determined depending on the numbers of perception states and emotion states defined for the software robot, the number of objects existing in the cyberspace, and the number of behavior types. The total number of episodes is computed by

$$total episode number = ( number of perception states + number of emotion states ) \times number of behavior types \times number of objects \qquad ( 3 )$$

An episode is stored in the episodic memory 60 in the following manner. The software robot manifests a specific behavior according to an external event, environmental information, an internal state, and a user's guidance. The behavior in turn changes at least one of an associated emotion state and an associated perception state. The types of emotion states and perception states associated with the specific behavior are predetermined according to artificial chromosomes unique to the software robot. Also, the variations of the emotion states and perception states are predetermined. As the specific behavior is executed, the episodic memory 60 identifies the type of the specific behavior and determines an object associated with the specific behavior, and a category, a state type, and a state variation according to internal states of the software robot changed by the specific behavior. The episodic memory 60 searches for an episode corresponding to a combination of the behavior type, the object, the category, the state type, and the variation.

If the episodic memory 60 fails to detect the episode, it additionally stores the episode as a new episode. The frequency of the new episode is 1 and the variation is calculated by the following representative variation formula and then stored. If the episodic memory 60 detects the episode, it calculates a representative variation based on a variation stored for the episode and a variation that has been caused by the specific behavior. Then the episodic memory 60 updates the episode by updating the frequency.

For example, if the software robot executes the behavior of “eating object 1” and state types that change in association with object 1 are hunger (−10) and happiness (+5), the episodic memory 60 searches for an episode corresponding to eat-object 1-perception-hunger-(x) and an episode corresponding to eat-object 1-emotion-happiness-(x). Herein, x is a variation. If the episodic memory 60 fails to detect these episodes, it adds an episode corresponding to eat-object 1-perception-hunger(A) and an episode corresponding to eat-object 1-emotion-happiness(A). A is a representative variation computed by equation (4). Meanwhile, if the episodes are detected, the episodic memory 60 detects variations from the detected episodes and calculates representative variations using the detected variations and variations generated by the specific behavior. The generated variations are predetermined.

Since the episodic memory 60 stores a result of learning by a behavior, it does not store a variation generated by the behavior, as it is. Rather, it calculates a representative variation reflecting a degree of learning and stores the representative variation for an associated episode. Therefore, the detected variation is an old representative variation and the representative variation is computed by

representative variation=(1−p)×old representative variation+p×generated variation (4)

where p is a predetermined constant indicating how much the generated variation affects the representative variation, ranging from 0 to 1 (0<p<1).

The above-described learning scheme of the episodic memory 60 is based on the assumption that perception states are independent of emotion states in order to memorize a variety of relations in a small-capacity memory. That is, when a behavior is manifested, independent memorizing of each perception state and each emotion state leads to storage of a large volume of information in a small-capacity memory. The episodic memory 60 can be so configured as to implement the learning process periodically because the episodic memory 60 memorizes the variations of perception states and emotion states and thus learning at appropriate intervals is effective.

The short-term memory 70 is a memory for storing latest information generated for a short time, in which the locations of other objects relative to the location of the software robot are stored as Sensory Ego Sphere (SES) values together with time t using three variables γ, θ, and φ on a spherical coordinate system. These SES values include time information related to incidences occurring in a certain area and information about the locations of objects on the sphere, and are provided when necessary. The short-term memory 70 stores information about objects around the software robot and the uncertainty levels of the information. When a particular object, i.e. an object of interest is recognized, referring to the sensor value 94 on the blackboard 90, the short-term memory 70 stores information about the location of the object along with an uncertainty level of 0. Thereafter, if the object of interest is not recognized again, the uncertainty level increases gradually over time. On the other hand, if the object of interest is recognized again, the location information is updated and the uncertainty level drops to zero. The software robot apparatus preliminarily stores a unique object focused distance for each object type related to each software robot, as part of artificial chromosomal information of the software robot. Accordingly, the software robot apparatus recognizes the object which is located within the object focused distance, closest to the software robot as an object of interest.

The behavior manager 40 is a module for finally determining the behavior of the software robot. The behavior manager 40 determines a behavior, referring to the perception value 96 and the emotion value 97 on the blackboard 90, the SES values of the short-term memory 70, and the object of interest, multiple episodes of the episodic memory 60, and the behavior object 98. Accordingly, the behavior manager 40 outputs a final behavior object 98 to the blackboard 90. The behavior manager 40 determines a behavior, basically referring to the episodic memory 60, and if it is inevitable, controls a guide behavior according to a user's guidance. The emotion value 97 is not related to behavior selection itself, just affecting the way the selected behavior itself is executed. That is, after the behavior of “walking” is selected, an emotion is involved in giving a subtle feature to the behavior, such as “happily walking”, “walking sulkily”, and the like. In addition, if the perception value 96 and the emotion value 97 fall within unstable state ranges, the behavior manager 40 determines the resulting behavior, referring to the episodic memory 60. Each perception state and each emotion state can be unstable. The unstable state ranges are predetermined genetic values being internal constants of the software robot.

An unstable state can be defined for every perception state and emotion state. In other words, the unstable state signifies a state where a respective current perception value 96 and a current emotion value 97 is less than a minimum threshold value or beyond a maximum threshold value or within the range between the minimum threshold value and the maximum threshold value that is respectively set for one of an associated perception state and an associated emotion state. Minimum and maximum threshold values that define an unstable state range for each state are given as genetic values of each software robot. In this manner, the unstable state ranges of perception and emotion states vary with the types of the perception and the emotion states and genetic values. In general, even though it is said that a state is unstable when its value is less than a minimum threshold value or greater than a maximum threshold value, the range of the unstable state can also be set between the minimum threshold value and the maximum threshold value depending on a user, a software robot, and the type of the state.

For each state, a warning value representing an instability level is computed based on the current perception value 96 and emotion value 97, and an unstable state range set for the state. A formula for computing the warning value can be defined in various ways based on the unstable state range. For example, when the unstable state range is less than a minimum threshold value or greater than a maximum threshold value, the warning value can be set to be a value obtained by subtracting a current state value from the minimum threshold value or the maximum threshold value.

When light (PERCEPT_LIGHT), sound (PERCEPT_SOUND), hunger (PERCEPT_HUNGER), fatigue (PERCEPT_FATIGUE), hit (PERCEPT_HIT), and pat (PERCEPT_PAT) listed in Table 9 are given as basic perception states, unstable state ranges and warning values can be derived for hunger and light, as illustrated in Table 11 below.

```
TABLE 11
  // PERCEPT_HUNGER
  if (HUNGER perception value > HUNGER perception maximum
threshold value){
    warning[PERCEPT_HUNGER] = HUNGER perception
  maximum threshold value − HUNGER perception value;
  }
  // PERCEPT_LIGHT
  if (LIGHT perception value < LIGHT perception minimum threshold
  value){
    warning[PERCEPT_LIGHT] = LIGHT perception minimum
  threshold value − LIGHT perception value
  }
  if (LIGHT perception value > LIGHT perception maximum threshold
  value){
  warning[PERCEPT_LIGHT] = LIGHT perception maximum threshold
value − LIGHT perception value
    }
```

For example, if at least one of a hunger value is too high, an ambient light is too strong, and a sadness value gets higher, it can be said that the software robot is in an unstable state emotionally or perceptively. In this regard, a score indicating a stability level of a life in perception and emotion related to the unstable state is introduced, for use in determination of a behavior. That is, when at least one state becomes unstable, the behavior manager 40 searches multiple episodes memorized in the episodic memory 60, and determines a behavior object 98 by selecting a combination of a behavior and an object capable of increasing a score associated with the current unstable state to the highest. This will be described in more detail hereinbelow.

When at least one of a perception and an emotion state becomes unstable, the behavior manager 40 searches for the warning values of all perception states and detects a perception state having the largest warning value. When each state value is updated, it is determined whether the state is unstable and the determination can be made by one of the behavior manager 40, the physical state unit 10, the perception unit 20, and the emotion state unit 30. The largest warning value means the most unstable state. The behavior manager 40 notifies the episodic memory 60 of the largest warning value and the perception state having the largest warning value. Here, the perception state having the largest warning value is called a main perception state.

Then the episodic memory 60 performs a primary search to detect at least one episode including a perception category and the main perception state. The episodic memory 60 checks out each detected episode to ascertain whether or not an object included in it is stored in the short-term memory 70. In the absence of the object in the short-term memory 70, the episode is excluded from the results of the primary search.

In another exemplary embodiment of the present invention one of a specific warning value and a warning value increase/decrease direction can be set selectively as a condition for performing the primary search. For example, the primary search may be set to be performed when the warning value of the main perception state exceeds a predetermined value, or only when a current warning value is one of greater than and less than a warning value of the latest primary search.

Each episode detected by the primary search includes behavior, object, category, state type, variation, and frequency. These episodes are identical in category and state type. For better understanding of the description, an episode having “perception” as a category is referred to as a perception episode, and an episode having “emotion” as category is referred to as an emotion episode.

For each of the primary-searched perception episodes, the episodic memory 60 performs a secondary search to detect emotion episodes including the same behavior and object as those of the primary-searched episode. A score is calculated by summing the variations of the detected emotion episodes, for each perception episode detected by the primary search. That is, the score is the sum of the variations of emotion episodes, each having the same behavior and the same object. When the emotion state type of an emotion episode detected by the secondary search is an affirmative emotion such as happiness, the variation of the emotion episode is added as it is to the score. In contrast, when the emotion state type of the emotion episode is a negative emotion such as sadness, anger, or fear, the variation of the emotion episode is subtracted from the score. The score has an initial value of “0”, and the types of affirmative emotions and negative emotions are predetermined. The sum of the variations of all emotion episodes detected for a particular behavior and a particular object during the secondary search is determined to be a final score. Then the type of the object used as a basis for the secondary search is compared with that of an object currently most focused on the blackboard 90. When they are identical, a certain compensation value is added to the final score.

The secondary search and the score calculation are performed for every perception episode detected by the primary search. The behavior manager 40 selects a behavior and an object of a perception episode having the highest score value and executes the behavior.

For example, if all the episodes within the episodic memory 60 have the same variation, 100, there is no focused object. Further, if three perception episodes 5, 7, and 10 are detected by the primary search, and if the secondary search for each of the three perception episodes reveals that three emotion episodes having emotion states of happiness, happiness, and sadness respectively are detected for perception episode 5, four emotion episodes respectively having emotion states of sadness, sadness, happiness, and happiness are detected for perception episode 7, and five emotion episodes respectively having emotion states of happiness, happiness, happiness, sadness, and happiness are detected for perception episode 10, the final score of perception episode 5 is 100 (=100+100−100), the final score of perception episode 7 is 0 (=−100−100+100), and the final score of perception episode 10 is 300 (=100+100+100−100+100). As a result, the episodic memory finally selects perception episode 10 and the behavior and object of perception episode 10 become the behavior object 98.

Manifestation of the selected behavior object 98 may relive the unstable state and affects related episodes. The behavior selection method as described above is based on the assumption that all behaviors are manifested only by learning. Therefore, in the case of a behavior that has not been learned in the behavior selection process, a predetermined default behavior is selected.

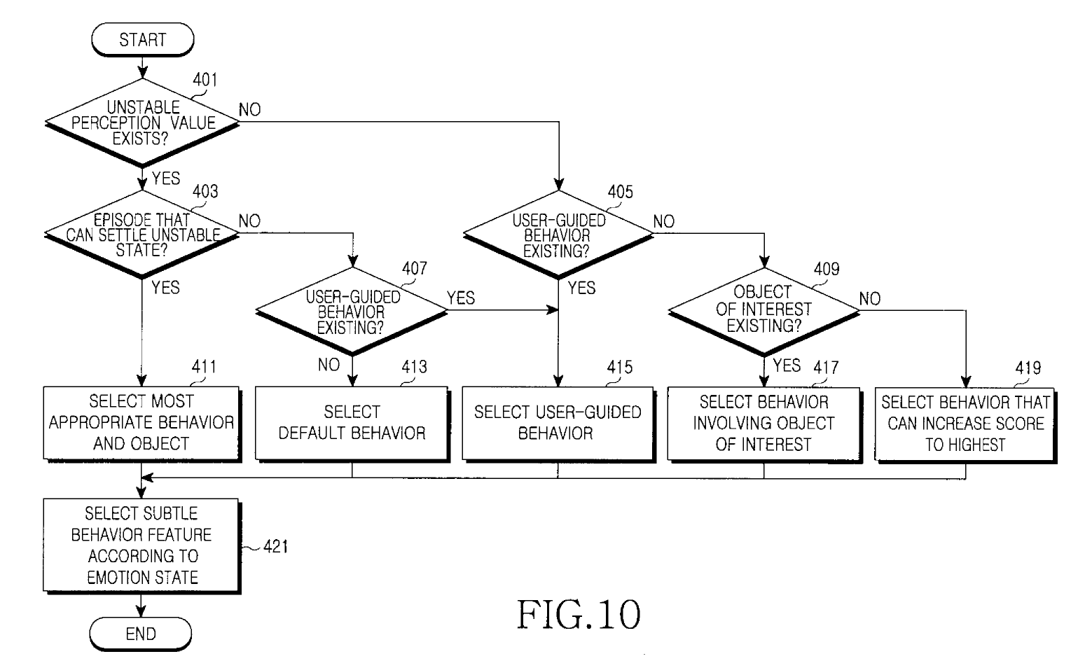

FIG. 10 illustrates the behavior determination operation of the behavior manager 40. Referring to FIG. 10, when there is one of an unstable perception state value and an unstable emotion state in step 401, the behavior manager 40 searches for an episode that can settle the unstable state in step 403. In the presence of the episode, the behavior manager 40 proceeds to step 411 and in the absence of the episode, the behavior manager 40 goes to step 407.

In step 411, the behavior manager 40 selects the most appropriate behavior and object in the episodic memory 60. Steps 403 and 411 correspond to the primary and secondary searches and the score calculation. In step 421, the behavior manager 40 selects a subtle behavior feature for the behavior according to the current dominant emotion state of the software robot.

Meanwhile, in the absence of the episode that can settle the unstable state in step 403, the behavior manager 40 determines whether there is a behavior guided by the user in step 407. In the presence of a user-guided behavior, the behavior manager 40 selects the user-guided behavior in step 415 and then proceeds to step 421. In contrast, in the absence of a user-guided behavior, the behavior manager 40 selects a default behavior in step 413 and then proceeds to step 421.

If there is neither an unstable perception state nor an unstable emotion state in step 401, the behavior manager 40 decides as to the presence or absence of a user-guided behavior in step 415. In the presence of a user-guided behavior, the behavior manager 40 selects the user-guided behavior in step 415 and then proceeds to step 421. In contrast, in the absence of a user-guided behavior, the behavior manager 40 determines whether there is an object of interest in step 409. In the presence of an object of interest, the behavior manager 40 searches for episodes related to the object of interest and selects a behavior involving the object of interest in the episodic memory 60 in step 417. This episode search is similar to the process of episode search and behavior selection that happen after sensing the unstable state in step 40i, i.e. the primary and secondary searches and the score calculation. More specifically, when the behavior manager 40 detects an object of interest, that is, when there is an object of interest in the short-term memory 70, the episodic memory 60 searches for episodes including the object of interest and groups together as an episode group episodes having the same behavior. Then, episodes having a category of emotion are detected from each episode group and a score is calculated according to the score calculation method as described above. That is, the final score of each behavior is calculated. Then, the behavior manager 40 selects a behavior having the highest score. When the highest score is below a predetermined threshold, the behavior manager 410 does not execute any behavior for the object of interest.

If an object of interest is not detected, the behavior manager 40 selects a behavior capable of increasing the lowest score in relation to one of each current perception state and emotion state of the software robot in the episodic memory 60 in step 419 and selects a subtle behavior feature for the behavior according to the current dominant emotion state of the software robot in step 421. In an alternative exemplary embodiment step 419 is not performed.

The behavior selected by the behavior manager 40 is manifested by the actuator 50. The actuator 50 manifests the behavior, referring to the behavior object 98, determines a duration time for the behavior, generates an internal event 93 that caused the behavior, and outputs the internal event 93 to the blackboard 90.

The genetic code writer 110 provides a user interface by which the user can write a genetic code for each software robot in accordance with an exemplary embodiment of the present invention. Thus, the representation value of genetic information included in a genetic code can be changed according to the user's input, thereby creating a new genetic code. To allow a user of a general software robot to change a genetic code easily and intuitively, the genetic code writer 110 provides a writing window with intuition traits. An intuition trait is a way of branding a software robot based on its perceptive or emotional characteristics, for example, “Happy”, “Sad”, “Hungry”, “Sleepy”, and “Gorgeous”.

One intuition trait can be related to one or more pieces of genetic information according to its type, and vice versa. The value of the intuition trait is correlated with the parameter, i.e. representation value, of its associated genetic information. That is, the change of the intuition trait in turn changes the representation value of its associated genetic information, and vice versa. The change is made according to a preset formula that is determined according to the type of the intuition trait and the genetic information.

An intuition trait refers to a personality or an external state characteristic of a software robot, which is represented integrally based on pieces of genetic information. The intuition trait can be expressed as a parameter value. According to the present invention, genetic information may be composed of a pair of homologous chromosomes. The homologous chromosomes exhibit detailed traits associated with the genetic information and are represented as parameter values. A parameter value representing genetic information can be computed as a combination of the parameter values of the homologous chromosomes forming the genetic information.

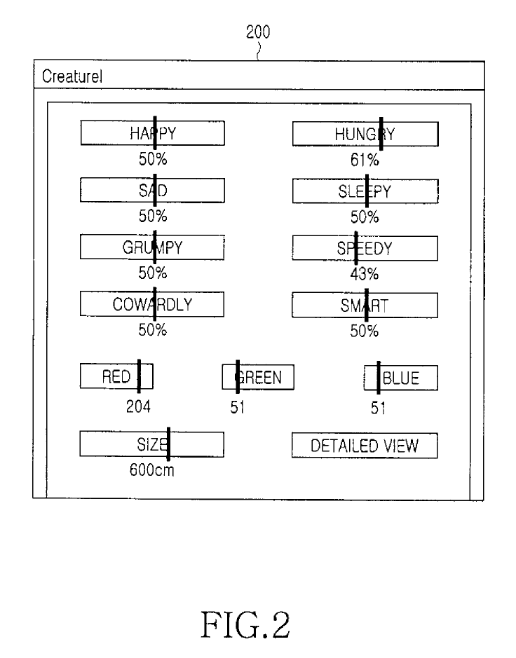

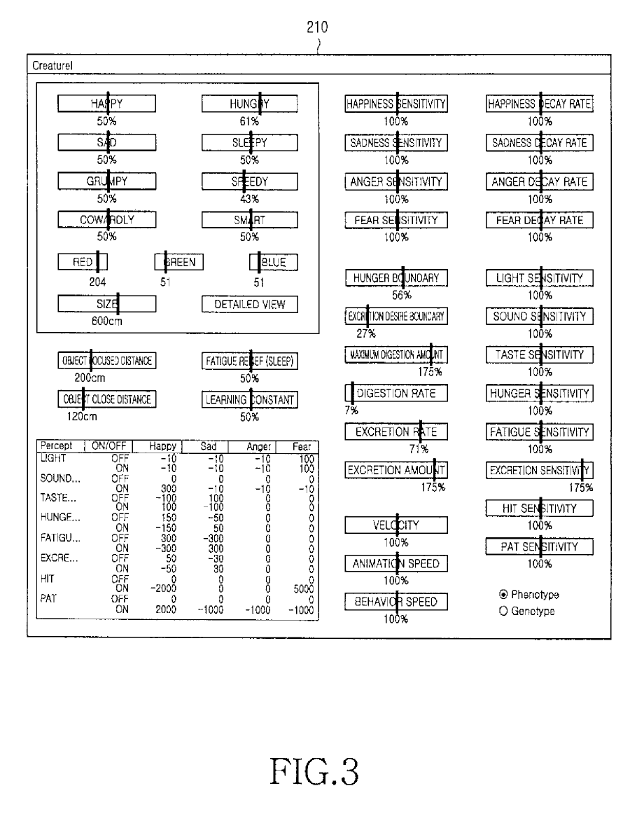

An example of an intuition trait writing window 200 for changing intuition traits is illustrated in FIG. 2. In addition, the genetic code writer 110 provides a detailed writing window 210 including the intuition trait writing window 200. The detailed writing window 210 is a user interface by which the user can change the representation value of genetic information included in a genetic code, as illustrated in FIG. 3. The user can change the value of an intuition trait or the representation value of genetic information in the detailed writing window 210 as well as in the intuition trait writing window 200. When changing the value of an intuition trait in the detailed writing window 210, the user can view changing of the representation value of associated genetic information. For example, when the user changes the value of an intuition trait, “Hungry”, the genetic code writer 110 changes the representation values of genetic information related to “Fatty”, i.e. a hunger boundary, an excretion desire boundary, a maximum digestion amount, a digestion rate, an excretion rate, the amount of wastes to be excreted, a hunger sensitivity, and an excretion sensitivity. Along with the change of the representation values of the genetic information, the genetic code writer 110 changes the chromosomal values of two homologous chromosomes in each piece of the genetic information according to a predetermined inheritance law.

Table 12 below describes genetic information classified for each component of the software robot apparatus according to an exemplary embodiment of the present invention. The representation value of each piece of genetic information can be set as a percentage of a reference value, and distance and speed are expressed in units of cm and cm/s, respectively.

TABLE 12

| | Member parameter | Description |
|---|---|---|
| Behavior manager | | |
| Hunger boundary | m_param_Hunger | Danger level of hunger (triggers |
| | | eating) |
| Excretion desire | m_param_Excretion | Danger level of excretion |
| boundary | | (triggers excretion) |
| Object close distance | m_param_CloseDistance | Distance within which virtual |
| | | creature can interact with object |
| Episodic Memory | | |
| Learning constant | m_param_LearningK | Learning rate constant used in |
| | | learning formula |
| Physical State | | |
| Maximum digestion | m_param_MaxDigestionValue | A maximum amount that can be |
| value | | digested for one tick |
| Digestion rate | m_param_DigestionRate | Rate at which food is absorbed |
| | | during digestion |
| Excretion rate | m_param_WastesRate | Rate at which intake is not |
| | | absorbed and thus to be excreted |
| Excretion amount | M_param_ExcretionValue | A maximum amount of wastes |
| | | that can be excreted for one tick |
| Fatigue relief rate | m_param_SleepActivity | Activity level recovered by |
| | | sleep for one tick |
| Perception | | |
| Object focused | m_param_FocusedDistance | Reference value for |
| distance | | computing focused object |
| Actuator | | |
| velocity | m_param_MoveSpeed | Movement speed of virtual |
| | | creature |
| Animation speed | m_param_AnimationSpeed | Animation speed of virtual |
| | | creature |
| Behavior speed | m_param_BehaviorSpeed | Behavior speed of virtual |
| | | creature |
| Emotion state | | |
| Perception weight | m_param_PerceptionK | Importance weight of each |
| | | perception |
| Emotion weight | m_param_EmotionK | Importance weight of each |
| | | emotion |
| Emotion decay rate | m_param_EmotionDecaryRateK | Constant determining |
| | | convergence characteristics |
| | | of each emotion |
| Perception-emotion | m_param_PerceotionToEmotion | A variation in emotion that a |
| table | | unit value of perception |
| | | causes |

Table 13 below illustrates relationships between intuition traits and genetic information according to an exemplary embodiment of the present invention.

TABLE 13

Happy=+(Emotion Weight: Happy)/2

−(Emotion decay rate: Happy)/2

Sad=+(Emotion Weight: Sad)/2

−(Emotion decay rate: Sad)/2

Grumpy=+(Emotion Weight: Anger)/2

−(Emotion decay rate: Anger)/2

Cowardly =+(Emotion Weight: Fear)/2

−(Emotion decay rate: Fear)/2

Hungry=−5×(hunger boundary)−(excretion desire boundary)

+(maximum digestion amount)/2−(digestion rate)
+(excretion rate)+(excretion amount)/2
+5×(Perception:Hunger sensitivity)/2
+(Perception:Excretion sensitivity)/2

Sleepy=+(Perception:Sleep sensitivity)/2

−(Fatigue relief rate)/2

Speedy=+(Velocity)/5

+(Animation speed)/2
+(Behavior speed)/2

Smart=+(Learning constant)×10

+(Perception:Hit sensitivity)/2
+(Perception:Pat sensitivity)/2

FIG. 4 is a flowchart illustrating an operation for changing genetic information by changing an intuition trait in the genetic code writer 110.

Referring to FIG. 4, the genetic code writer 110 displays an intuition trait writing window corresponding to a genetic code of a software robot, upon request of the user in step 241. The genetic code writer 110 changes the value of a selected intuition trait in response to a user's input in step 243 and changes the representation value of each piece of genetic information related to the selected intuition trait by a predetermined conversion formula in step 245. In step 247, the genetic code writer 110 changes the chromosomal values of the homologous chromosomes of each piece of genetic information whose representation value has been changed. When the user manipulation is completed, the genetic code writer 110 stores the changed genetic code in correspondence with the software robot in the memory 120 in step 249 and ends the operation. The genetic code writer 110 can store backups of an original genetic code and the genetic code set before the change occurs.

Meanwhile, the genetic code writer 110 can implement a crossover between software robots in accordance with an exemplary embodiment of the present invention. The crossover is the process of creating a new genetic code by combining related homologous chromosomes between genetic information counterparts included in genetic codes of two different software robots. A software robot participating in the crossover is called a parent and an offspring software robot having the new genetic code is called a child.

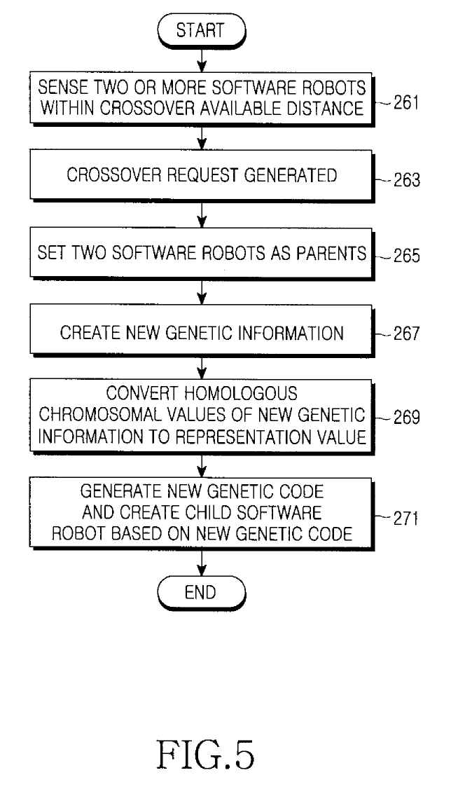

With reference to FIG. 5, the crossover will be described below. Referring to FIG. 5, the genetic code writer 110 senses two or more software robots within a crossover available distance in step 261. The crossover available distance is preset as a distance within which a crossover can happen in a cyberspace or an actual space. Upon receipt of a crossover request between two software robots from the user in step 263, the genetic code writer 110 sets the two software robots as parents in step 265. The two software robots can be selected by the user or the closest software robots within the crossover available distance can be selected. Then the genetic code writer 110 creates a new genetic code by combining the homologous chromosomes of genetic information counterpart among the genetic information of the parents according to a predetermined genetic crossover rule in step 267. In other words, the homologous chromosomes of genetic information counterparts in the genetic information included in the genetic codes of the parents are combined according to a predetermined genetic crossover rule. The genetic crossover rule is the way in which the two homologous chromosomes of first genetic information in a first parent are combined with those of first genetic information in a second parent. It can be set in various ways. It can be set depending on the type of genetic information, or randomly.

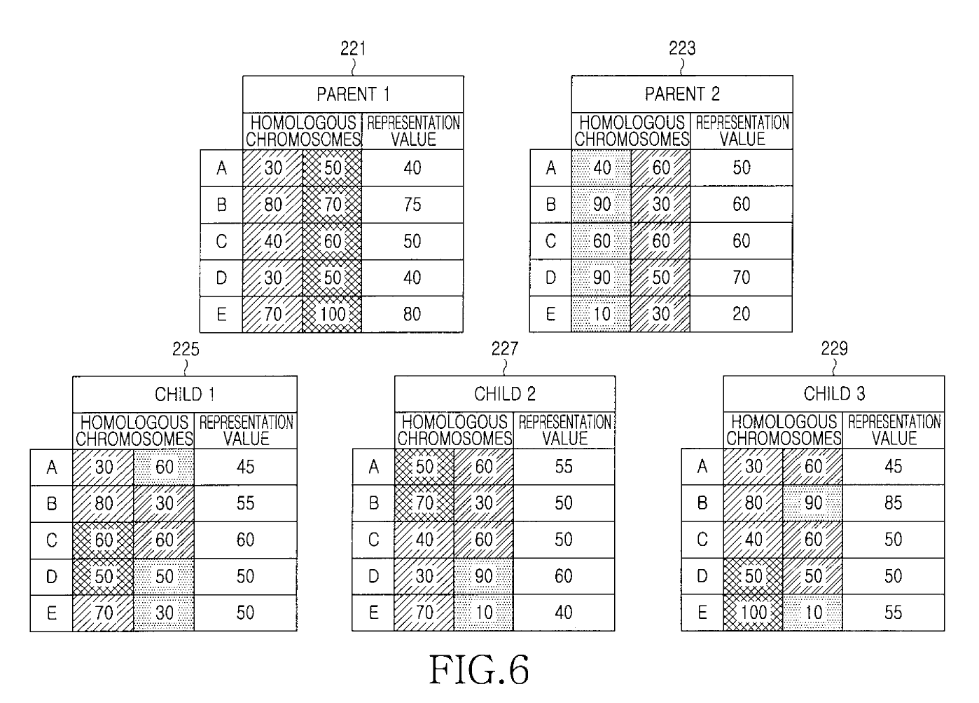

FIG. 6 illustrates the compositions of artificial chromosomes of parents and their children according to an exemplary embodiment of the present invention. Referring to FIG. 6, the genetic codes of each of a first parent 221 (parent 1) and a second parent 223 (parent 2) include genetic information A, B, C, D, and E. An inheritance law is set such that the representation value of genetic information is the mean of the chromosomal values of paired homologous chromosomes constituting the genetic information. Therefore, genetic information A of Parent 1 has two homologous chromosomes with values 30 and 50, respectively and has a representation value of 40. Genetic information of each of first, second and third children 225, 227 and 229 (child 1, child 2 and child 3) is combinations of the homologous chromosomes of genetic information A, B, C, D and E of parent 1 and parent 2. The genetic information has a representation value equal to the mean of two homologous chromosomal values. The unique traits of the children are manifested in correspondence with representation values.

Referring to FIG. 5 again, when the new genetic information is completely generated, the genetic code writer 110 produces a representation value based on the chromosomal values of the homologous chromosomes of the new genetic information according to the inheritance law in step 269 and creates a new genetic code and a child software robot based on the new genetic code in step 271.

Other exemplary embodiments of the crossover operation according to the present invention are illustrated in FIGS. 7A to 7D. FIG. 7A illustrates genetic codes of a parent software robot with an ID of 271631 and its appearance based on the genetic codes, FIG. 7B illustrates genetic codes of a parent software robot with an ID of 293024 and its appearance based on the genetic codes, FIG. 7C illustrates a crossover request window in which the user can enter a crossover request and crossover conditions, and FIG. 7D illustrates genetic codes of a child software robot with an ID of 22043384 and its appearance based on the genetic codes. The user can set an inheritance law when requesting a crossover, and in accordance with an exemplary embodiment of the present invention, he can also set a genetic crossover rule.

Referring to FIGS. 7A to 7D, genetic information included in the genetic codes of the software robots with the IDs of 271631, 293024, and 22043384 specifies S face, S ear, S eye, S nose, S mouth, C face, C ear, C eye, C nose, and C mouth. Each piece of genetic information has homologous chromosomes, Gene 1 and Gene 2.

Referring to FIG. 7A, in the parent software robot with the ID of 271631, Gene 1 and Gene 2 have a value of 120 for S face, 30 for S ear, 25 for S eye, 30 for S nose, 25 for S mouth, 753 for C face, 643 for C eye, 0 for C eye, 532 for C nose, and 864 for C mouth. The representation value P of each piece of genetic information is the mean of the two homologous chromosomes of the genetic information.

Referring to FIG. 7B, in the parent software robot with the ID of 293024, Gene 1 and Gene 2 have a value of 80 for S face, 20 for S ear, 15 for S eye, 10 for S nose, 10 for S mouth, 999 for C face, 777 for C eye, 333 for C eye, 555 for C nose, and 666 for C mouth. The representation value P of each piece of genetic information is the mean of the two homologous chromosomes of the genetic information.

Referring to FIG. 7D, in the child software robot with the ID of 22043384 that inherits all the homologous chromosomes of parent 1 and parent 2, Gene 1 has a value of 120 for S face, 30 for S ear, 25 for S eye, 30 for S nose, 25 for S mouth, 753 for C face, 643 for C eye, 0 for C eye, 532 for C nose, and 864 for C mouth. Gene 2 has a value of 80 for S face, 20 for S ear, 15 for S eye, 10 for S nose, 10 for S mouth, 999 for C face, 777 for C eye, 333 for C eye, 555 for C nose, and 666 for C mouth. Hence, the child software robots have a representation value of 100 for S face, 25 for S ear, 20 for S eye, 22 for S nose, 17 for S mouth, 876 for C face, 655 for C eye, 111 for C eye, 543 for C nose, and 765 for C mouth.

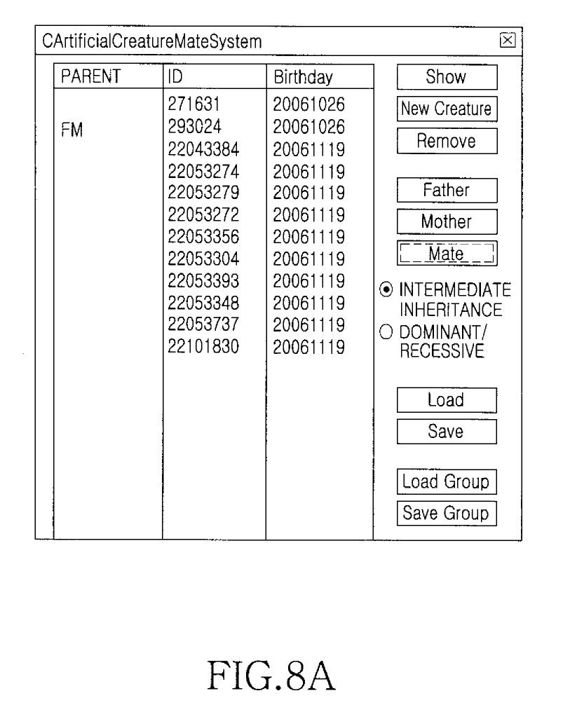

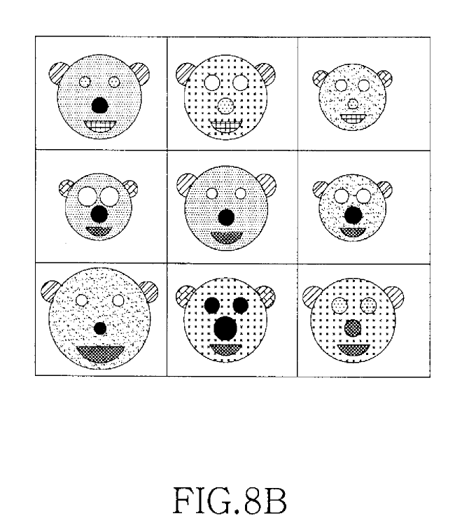

In accordance with an exemplary embodiment of the present invention, a single software robot can be set as both parents from whom a child is born by self crossover, as illustrated in FIGS. 8A and 8B. In the illustrated case of FIGS. 8A and 8B, the software robot with the ID of 22043384 plays a role of both parents and gives birth to nine children.

As is apparent from the above description, the present invention enables a user to easily modify or construct a genetic code for a software robot by providing an intuition trait changing function and a software robot crossover function. Also, the present invention allows the user to design a genetic code for a software robot easily and intuitively and to design genetic codes for various software robots by crossover.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for operating an artificial creature having a unique genetic code and capable of moving, the genetic code including at least one piece of genetic information, the method comprising:
receiving an intuition trait value associated with at least one piece of genetic information among pieces of genetic information included in the genetic code from a user;
updating an existing intuition trait with the received intuition trait value;
changing a representation value of the associated at least one piece of genetic information based on the updated intuition trait; and
operating the artificial creature according to the changed representation value.

2. The method of claim 1, wherein the genetic information includes at least one of an inner state representation value, an external stimulus representation value, and behavior determining genetic information.

3. The method of claim 1, wherein the intuition trait value represents one of a plurality of perceptive and emotional traits.

4. The method of claim 1, wherein the genetic information changes according to one of an inner state change and an external state change and is a unique value to the artificial creature, determined by a user input.

5. The method of claim 1, wherein the artificial creature is one of a genetic robot and a software robot.

6. A method for designing a genetic code for a software robot in a software robot apparatus, comprising;
receiving a request for writing a genetic code for a software robot from a user;
providing a plurality of intuition traits associated with at least one piece of genetic information included in the genetic code;
changing a value of an intuition trait selected from among the plurality of intuition traits according to a user input;
changing a representation value of each piece of genetic information related to the selected intuition trait by applying the changed value of the intuition trait to a predetermined conversion formula; and
implementing the software robot according to representation values of the at least one piece of genetic information included in the genetic code, an external stimulus, and an internal state change of the software robot.

7. The method of claim 6, further comprising, upon receipt from the user of a request for changing a representation value of a certain genetic information, changing the representation value of the certain piece of genetic information and changing a value of an intuition trait related to the certain piece of genetic information according to a predetermined conversion formula.

8. The method of claim 7, further comprising, after changing the representation value of the certainpiece of genetic information, changing values of a pair of homologous chromosomes constituting the certain piece of genetic information based on the change representation value according to a predetermined inheritance law.

9. The method of claim 8, wherein the inheritance law is an application of a biological inheritance law.

10. The method of claim 8, wherein the inheritance law is set by applying one of the laws selected from the group consisting of Mendelian genetics, law of intermediate inheritance, law of independence assortment, law of segregation, and law of dominance.

11. A method for designing a genetic code for a software robot in a software robot apparatus, comprising;
setting genetic code of at least one software robot as a genetic code of each of a pair of parent software robots; and
creating new genetic information by combining paired homologous chromosomes of genetic information counterparts included in genetic information provided by the genetic code of each of the pair of the parent software robots, according to a predetermined gene crossover rule.

12. The method of claim 11, further comprising:
completely designing a new genetic code by converting values of a pair of homologous chromosomes constituting each piece of the created new genetic information to a representation value of each piece of genetic information according to a predetermined inheritance law; and
creating a child software robot according to representation values of genetic information included in the new genetic code.

13. The method of claim 12, wherein two different software robots are set as the pair of parent software robots.

14. The method of claim 12, wherein the genetic code setting comprises setting a genetic code of a single software robot as the genetic code of each of the pair of parent software robots.

15. The method of claim 12, wherein the inheritance law is an application of a biological inheritance law.

16. The method of claim 15, wherein the inheritance law is set by applying one of laws selected from the group consisting of Mendelian genetics, law of intermediate inheritance, law of independence assortment, law of segregation, and law of dominance.

17. The method of claim 12, wherein the gene crossover rule is a rule that randomly combines paired homologous chromosomes constituting genetic information counterparts in each of the pair of parent software robots.

18. The method of claim 12, wherein the genetic code setting comprises:
sensing whether at least two different software robots are located within a crossover available distance;
setting, if it is sensed that two different software robots are located within the crossover available distance, genetic codes of the two software robots as the genetic codes of the pair of parent software robots;
setting, if it is sensed that three different software robots are located within the crossover available distance, genetic codes of two closest software robots as the genetic codes of the pair of parent software robots; and
setting, if it is sensed that at least four different software robots are located within the crossover available distance, genetic codes of software robots selected by a user as the genetic codes of the pair of parent software robots.

19. The method of claim 6, wherein the genetic code includes at least one personality gene related to at least one internal state of the software robot and at least one outward gene related to an outer appearance of the software robot.

20. The method of claim 11, wherein each of the genetic codes includes at least one personality gene related to at least one internal state of a software robot and at least one outward gene related to an outer appearance of the software robot.
